(19) United States
(12) Patent Application Publication
(10) Pub. No.: US 2024/0224943 A1
(43) Pub. Date: Jul. 11, 2024

(54) PET LEASH SLEEVE

(71) Applicant: Mayor Tyson Bulldog LLC, Washington, MI (US)

(72) Inventor: Michelle Naumovski, Washington, MI (US)

(73) Assignee: Mayor Tyson Bulldog LLC, Washington, MI (US)

(21) Appl. No.: 18/406,106

(22) Filed: Jan. 6, 2024

Related U.S. Application Data
(60) Provisional application No. 63/437,634, filed on Jan. 6, 2023.

(51) Int. Cl. A01K 27/00

(52) U.S. Cl. CPC A01K 27/006

(57) ABSTRACT

A pet leash sleeve which is constructed of a sturdy durable fabric, such as canvas or nylon/poly pack cloth, is generally tubular and configured to surround the lead of a standard pet leash. The pet leash sleeve includes a metal clip, such as a carabiner, on one end, that interconnects with the hardware on the pet leash. In combination with the sturdy construction of sleeve itself, the metal clip prevents the pet leash sleeve from rotating around the lead of the leash and/or migrating to the other end of the lead. The pet leash sleeve can be placed, at the handler's discretion, either at the end of the leash nearest the animal or the end of the leash nearest the handle for maximum visibility.

### CROSS REFERENCE TO RELATED APPLICATIONS

This application claims the benefit of the filing date of US Provisional Patent Application U.S. Ser. No. 63/437634 filed on Jan. 6, 2023, the disclosure of which is incorporated herein by reference.

### TECHNICAL FIELD

This invention relates generally to an accessory for a pet leash, and more particularly, to a pet leash sleeve with a printed message or decoration.

### BACKGROUND

Slip-on pet leash covers, or pet leash sleeves, are known and used to convey a message to a passerby, such as “please do not pet,” or “dog in training.” In this manner, one can communicate with others while walking the dog and avoid someone attempting to pet an unfriendly dog, for example, or frightening an anxious dog. Of course, the message printed on the sleeve can be personalized to convey the dog's name or to decorate the leash with an amusing phrase or to promote a business, sports team, charity, or product.

Known pet leash sleeves typically comprise a rectangular sheet of a material that is placed around a pet leash and closed by the user to envelope the leash when the two long sides of the rectangular sheet of material are secured together with hook and loop fasteners (such as VELCRO® Brand hook and loop fasteners), buttons, or snaps. It is also known to provide a pet leash sleeve as a tubular sleeve which is dimensioned to slip over a leash. One such leash sleeve is shown in US Publication No. 2014/0041265.

One of the problems with known pet leash sleeves is that they can rotate around the leash and slide up and down over the length of the leash during use. There is, thus, a need for a dog leash sleeve that retains its position on the leash so that the message printed on the sleeve is oriented correctly and remains clearly visible to a passerby.

### SUMMARY

The foregoing and other objects are achieved by this invention which provides a pet leash sleeve which is a rectangular, generally tubular body that is sized to fit over the lead of a standard pet leash of the type which is commercially available. In accordance with the invention, the pet leash sleeve also has a metallic clip, which may be a carabiner, attached, or attachable, to one end of the rectangular generally tubular body.

Of course, a rectangular body has two long legs that are equal in length and parallel to each other separated by two perpendicular short legs that are also equal in length and parallel to each other, the short legs defining the width of the rectangle. In this case, the length of the short legs is selected so that the inner diameter of the generally tubular body is configured to slip over and accommodate the flexible lead of a leash.

Advantageously, a seam is placed proximate to, and runs lengthwise along, one of the long legs of the rectangular, generally tubular body so that the generally tubular body lies flat enough to create two exterior front-facing surfaces. As used herein, the term “front-facing surface” means an exterior surface of the generally tubular body that faces an observer, or passerby. The seam ensures that indicia can be placed on substantially flat, opposite exterior surfaces despite the tubular nature of the sleeve.

It is, of course, an important feature of this invention that the front-facing surfaces of the leash sleeve can be printed with a message or design, herein generically designated as indicia, and that such indicia are clearly visible to observers. Preferably, the leash sleeve body is printed on both sides of the sleeve with the text running in opposite directions so it is readable either way that the sleeve is attached to the leash as will be described more completely herein below.

The pet leash sleeve further includes a clip, which is preferably metal, that is attachable to hardware on the pet leash. The metallic clip can be a carabiner, or any other type of snap hook or clip, that opens to connect releasably to other hardware, such as the D-loops that might be on a pet leash. Heavy duty snap hook carabiners are preferred.

Since the body of the leash is tubular, the short legs are open and are referred to herein as open ends. The pet leash sleeve includes an arrangement for attaching the metallic clip to the pet leash sleeve on one of the open ends. In one example, the arrangement is a sewn-in loop of material, which may be a loop of the fabric used to construct the sleeve, though which the metallic clip is inserted.

In another example, the arrangement for attaching the metallic clip is a grommet that is inserted in one of the open ends of the tubular body. The grommet should be sized to accept the carabiner, or any other hardware, that is contemplated for use. The carabiner can be placed through the grommet to attach it to the sleeve. In the alternative, a metallic ring, such as an O-ring, illustratively, a key ring loop, can be placed through the grommet. The carabiner or other clip can then be attached to the sleeve through the key ring loop. The latter arrangement has the advantage that other items, such as charms or tags, can also be attached to the sleeve though the key ring loop.

These examples are meant to be illustrative, and the carabiner or other clip can be attached to the pet leash sleeve by any other known means provided the arrangement has an opening sufficient to accommodate the chosen clip, through one end of the sleeve.

Another advantageous aspect of the present invention is that the fabric and construction of the sleeve are superior to the sleeves presently sold in the marketplace. In one example, the leash sleeve of the present invention is constructed from a durable canvas that is capable of withstanding daily use. Advantageously, canvas is weatherproof and machine washable.

Good results have also been achieved with poly/nylon pack cloth having a denier in the range of 220 d to more than 400 d. In a specific preferred embodiment, 420 denier coated pack cloth is used to construct the sleeve. This particular fabric is 100% nylon and is coated in urethane so that it repels water and resists rips and tears. Of course, other sturdy fabrics, such as duck cloth, can be used in the practice of the invention provided that the fabric retains its shape in use. An interfacing can be used in the interior of the sleeve to ensure that the finished sleeve holds its shape well.

The dog leash sleeve of the present invention is sewn to form a rectangular tube-like structure that slides over a pet leash and has an attached metallic clip that cooperates with metal hardware of the type typically found on a leash and/or pet collar. Therefore, the pet leash sleeve is fabricated to have dimensions that are compatible with standard commercially-available pet leashes. However, the invention is not to be limited by the length, width, or inner diameter of the sleeve. In the specific illustrative embodiments presented herein, the finished sewn size of a large sleeve is 13″×2″ and a small sleeve is 8.5″×2″.

The standard elements comprising a pet leash are a flexible lead, which may be a length of metal chain, leather, rope, nylon webbing, or the like; a handle on one end of the lead, which may be a loop of the flexible lead material and preferably includes other hardware such as a slotted metal D-ring; and a metal spring clip, such as a trigger clip clasp or a swivel eye bolt snap hook, on the other end. The metal spring clip on the leash is attachable to metal hardware of the type typically found on a pet collar, harness, or halter. Most pet collars include a metal loop, such as a D-ring, to which the leash can be releasably fastened with the metal spring clip.

In use, the lead of a leash is threaded through the generally tubular body of the leash sleeve to envelop the same. The metallic clip, which is attached to one end of the tubular body, is configured to be attachable to the aforementioned elements of a standard pet leash so that the sleeve stays in place either near the point of contact between the pet's collar and the leash, or in the alternative, to a point of contact on the opposite end of the leash near the handle. Thus, the pet leash sleeve of the present invention can be positioned to ensure maximum visibility of any printing on the pet leash sleeve.

As indicated above, prior art pet leash sleeves tend to rotate around the leash and to slide up and down over the length of the leash during use. The inclusion of the metallic clip which interconnects with the hardware on the pet leash, in combination with the sturdy construction of sleeve itself, ensures that the pet leash sleeve of the present invention stays in place without rotating around the flexible lead or migrating to the other end of the lead. Moreover, the sleeve can be placed, at the handler's discretion, at either the end of the leash nearest the animal or nearest the handle for maximum visibility.

### BRIEF DESCRIPTION OF THE DRAWING

Comprehension of the invention is facilitated by reading the following detailed description, in conjunction with the annexed drawing, in which:

FIG. 1 is a top plan view of a pet leash sleeve in accordance with the present invention;

FIG. 2 is a perspective end view of one end of the generally tubular body of the pet leash sleeve of FIG. 1, showing an arrangement for attaching a carabiner to the pet leash sleeve;

FIG. 3 is a top plan view of a printed pet leash sleeve in accordance with the present invention;

FIG. 4 shows an alternate arrangement for attaching a carabiner to the pet leash sleeve;

FIG. 5 shows the pet leash sleeve of the present invention installed on a conventional pet leash at the end of the leash that attaches to hardware on the pet's collar; and

FIG. 6 shows the pet leash sleeve of the present invention installed on a conventional pet leash at the end of the leash that is near the handle.

### DESCRIPTION

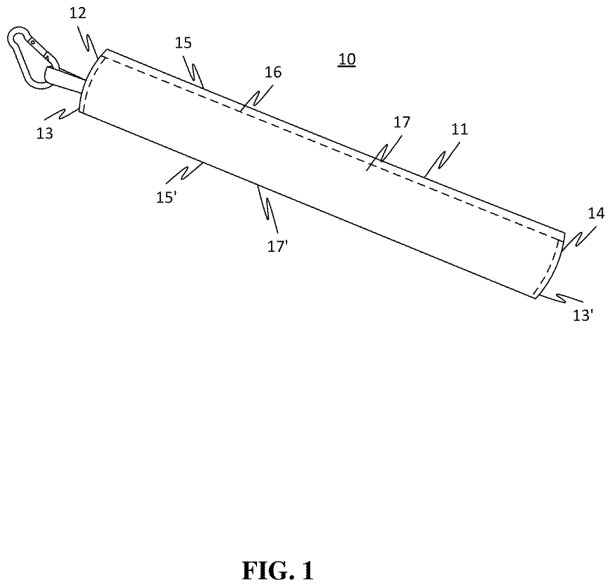

FIG. 1 shows a pet leash sleeve 10 in accordance with the present invention. Pet leash sleeve 10 comprises a rectangular generally tubular body 11 having a first open end 12 on a short leg 13, 13′ of the rectangular body and a second open end 14 distal to first open end 12. The rectangular body has two long legs 15, 15′. A seam 16, proximate to, and running lengthwise along long leg 15 ensures that generally tubular body 11 lays flat so that the leash sleeve has flat exterior, or front-facing surfaces 17, 17′.

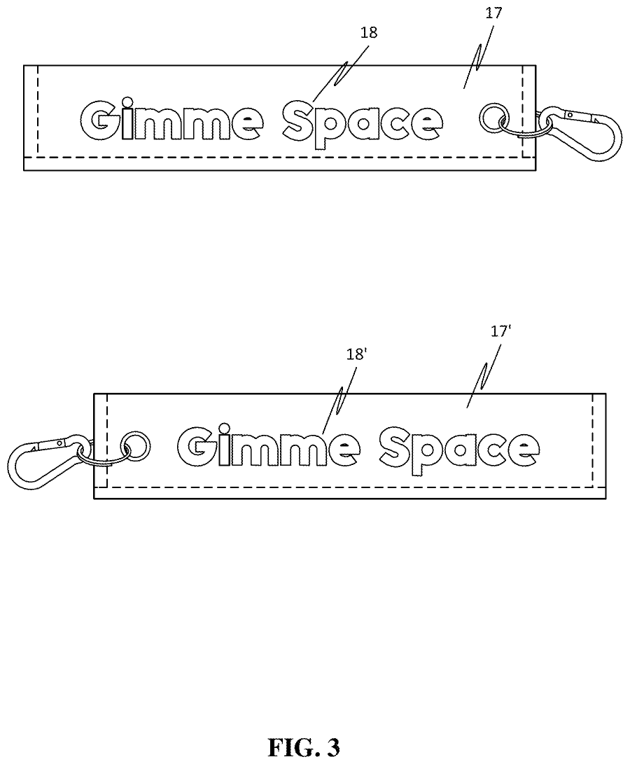

A message or other indicia 18, 18′ is printed on flat front-facing surfaces 17, 17′ of the leash sleeve as shown in FIG. 3. The reference numbers for identical elements will remain the same in all figures. Referring to FIG. 3 (upper figure), indicia 18, which in this figure is the word “GIMME SPACE” printed on front-facing surface 17 of pet leash sleeve 10. Flipping pet leash sleeve 10 over, so that opposing side of the pet leash sleeve is the front-facing surfaces 17′ (lower figure), shows that indicia 18′ is printed in the opposite direction. In this manner the pet leash sleeve can be attached to hardware at the end of the leash that attaches to the hardware on the dog's collar or to the handle of the leash and is readable in either direction.

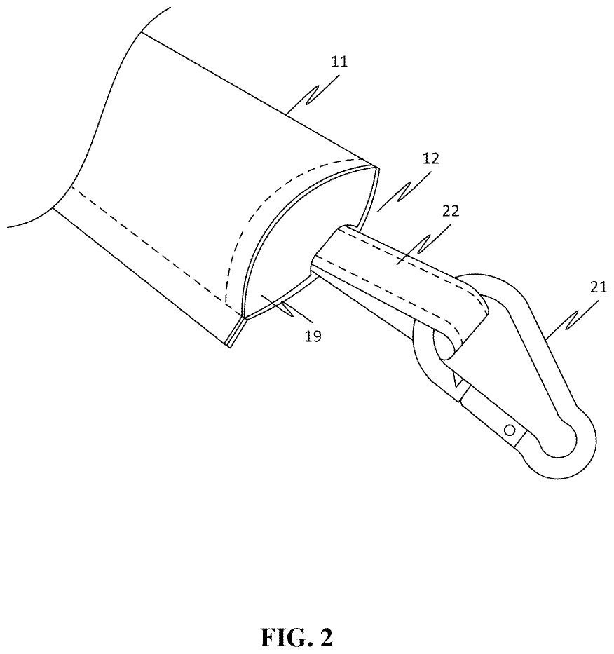

Referring to FIG. 2, a perspective view of open end 12, shows the tubular shape of generally tubular body 11 which, as previously indicated, is configured to accommodate a flexible lead of a leash (not shown). In this embodiment, an arrangement for attaching a metallic clip to the pet leash sleeve is a fabric tab 22 which is sewn into one side of first open end 12 (see, also, FIG. 1) of generally tubular body 11. The metallic clip, specifically carabiner 21, is inserted through tab 22 to attach carabiner 21 to the open end 12 of generally tubular body 11.

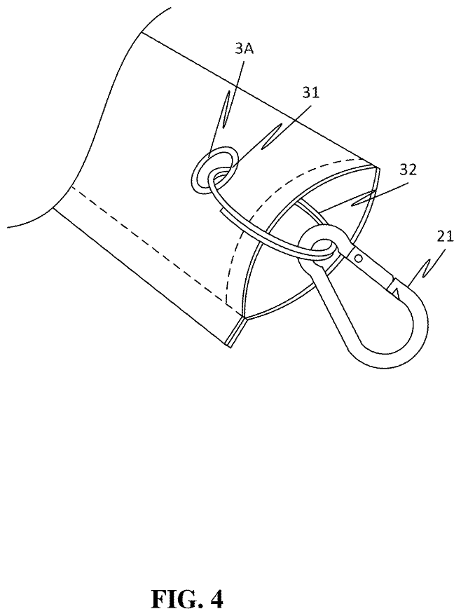

FIG. 4 shows an alternate arrangement for attaching a carabiner or other clip to generally tubular body 11. In this arrangement, a grommet 31, which is preferably metal, is placed on one side of generally tubular body 11 at first open end 12 (see, also FIG. 1). An O-ring 32, such as a key ring loop, is placed through grommet 31. Clip 21 is attached to O-ring 32. Advantageously, other items, such as a name tag or pet jewelry, can be attached to the pet leash sleeve through O-ring 32. Another advantage of using a grommet is that the grommet itself can be imprinted with indicia 34, shown here as a brand for the pet leash sleeve. Of course, the opening of the grommet must be sized to accept the key ring loop and/or clip or carabiner.

In one specific illustrative method of making embodiment, a finished sewn leash sleeve in accordance with the present invention is fabricated by the following method. It is to be understood, however, that this method of making is merely illustrative and that a person of ordinary skill in the art, such as a skilled seamstress, can easily develop other methods of fabricating the dog leash sleeve of the present invention.

The material, which in this specific embodiment is canvas, is cut into a rectangle according to a template. In the specific illustrative embodiments described herein, where the finished sewn product is 13″×2″ (Large Size) and 8.5″×2″ (Small Size), the dimensions of the rectangle are 10″×16″ and 8″×16″, respectively. Interfacing is cut in a similar fashion but 1″ shorter in length and ½″ less in width.

The material is folded in half, seamed down the center, and the seam is pressed open.

The sleeve is then turned inside out to form a tube, seamed on the left side (FIG. 1, long leg 15), and pressed flat.

The interfacing is folded in half, inserted into the sleeve, and pressed flat.

In embodiments where a fabric loop (FIG. 2, tab 22) is attached to one of the open ends of the tubular sleeve, a 1″ width of material is cut to form about a ½″×4″ tab. The tab is folded in half and sewn into the top of the sleeve on one side of an open end of the generally tubular body.

In embodiments where a grommet is used, a standard pair of eyelet pliers or a grommet punch kit is used to apply the grommet to one side of an open end of the generally tubular sleeve body. In this case, the punch can also be customized to place the manufacturer's brand on the grommet.

In one specific embodiment, iron-on transfer letters, specifically vinyl letters, are heat pressed onto the exterior front-facing surface of one, or preferably, both sides of the fabricated sleeve (FIG. 3, surfaces 17, 17′). Of course, other methods of printing, such as screen printing, can be used to place the message on the sleeve.

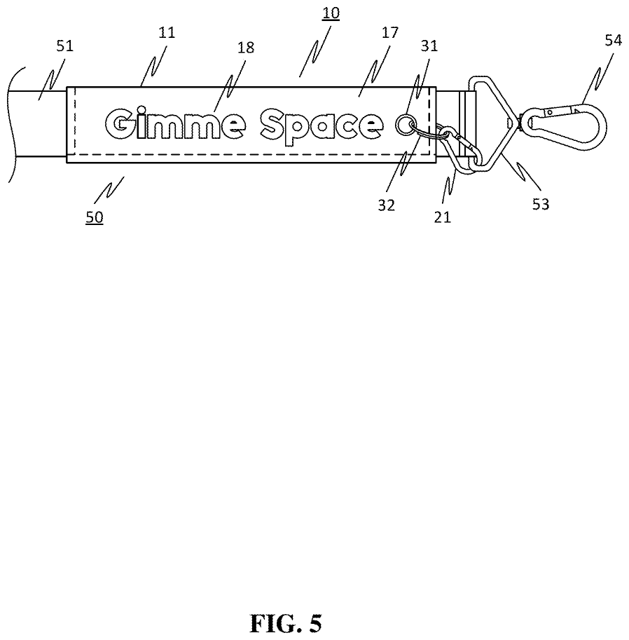

Reference to FIG. 5 shows a flexible lead 51, which is a strip of nylon webbing in this figure, at the end of a pet leash 50 terminating with hardware, such as D-ring 53 attached to metal spring clip 54, that attaches to hardware on the pet's collar, such as a D-ring (not shown). Pet leash sleeve 10 is installed, as shown in this figure, by sliding the generally tubular body 11 over leash lead 51 and attaching carabiner 21 to D-ring 53 so that the pet leash sleeve is near the animal. Alternatively, the generally tubular body 11 is flipped over and installed on the handle end of the leash (not shown in this figure).

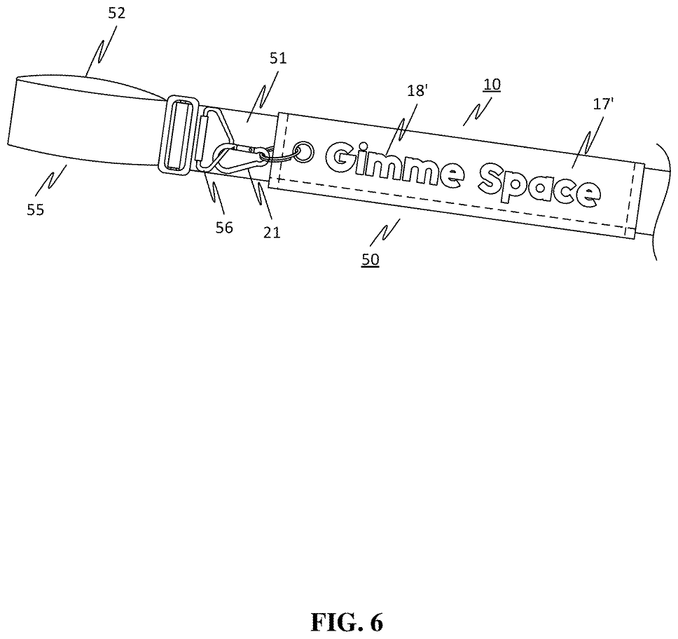

FIG. 6 shows the handle end 55 of pet leash 50. In this orientation, generally tubular body 11 is slid over handle 52, which may be a loop of webbing, and includes hardware such as slotted D-ring 56, to surround flexible lead 51 at handle end 55. Carabiner 21 is attached to slotted D-ring 56 near handle 52 to hold the pet leash sleeve in place. In this orientation, the indicia 18′ is on front-facing surface 17′.

Although the invention has been described in terms of specific embodiments and applications, persons skilled in the art may in light of this teaching, generate additional embodiments without exceeding the scope or departing from the spirit of the invention described herein. Accordingly, it is to be understood that the drawing and description in this disclosure are proffered to facilitate comprehension of the invention and should not be construed to limit the scope thereof.

What is claimed is:

1. A pet leash sleeve for a pet leash of a type having a flexible lead with a handle on one end and a metal clip on an end of the flexible lead distal to the handle, wherein the metal clip is attachable to metal hardware of a type typically found on a pet collar such as a D-ring or a loop, the pet leash sleeve comprising:
a rectangular generally tubular body constructed of a sturdy material having a first open end on one of two short legs of said rectangular generally tubular body and a second open end distal to the first open end, said rectangular generally tubular body having a seam proximate to, and running lengthwise on, one of two long legs of said rectangular generally tubular body, so that said elongated generally tubular body lies flat so as to define exterior front-facing surfaces, a length of the short legs of said rectangular generally tubular body being selected so that a diameter of said rectangular generally tubular body is configured to accommodate the flexible lead of a leash;
an arrangement for attaching a metallic clip to one side of the first open end; and
the metallic clip attached to said arrangement, said metallic clip being configured to be attachable to metal hardware on the pet leash.

2. The pet leash sleeve of claim 1, further including indicia printed on at least one front-facing surface of said rectangular generally tubular body.

3. The pet leash sleeve of claim 2, wherein the indicia is printed on both front-facing surfaces of said rectangular generally tubular body, the indicia running in opposite directions on opposing front-facing surfaces.

4. The pet leash sleeve of claim 1, wherein said rectangular generally tubular body is constructed of a sturdy canvas.

5. The pet leash sleeve of claim 1, wherein said rectangular generally tubular body is constructed of a nylon poly pack cloth.

6. The pet leash sleeve of claim 1, wherein said arrangement for attaching the metallic clip is a looped tab placed on one side of the first open end of said rectangular generally tubular body, the looped tab being configured to receive said metallic clip.

7. The pet leash sleeve of claim 1, wherein said arrangement for attaching the metallic clip is a grommet that is placed through one side of the first open end of said rectangular generally tubular body, the grommet being configured to receive said metallic clip.

8. The pet leash sleeve of claim 7, further including an O-ring inserted in the grommet and adapted to receive said metallic clip.

9. The pet leash sleeve of claim 1, wherein said metallic clip is a carabiner.
